(19) United States
(12) Patent Application Publication
(10) Pub. No.: US 2017/0279667 A1
(43) Pub. Date: Sep. 28, 2017

(54) PROVIDING A REDUNDANT CONNECTION IN RESPONSE TO A MODIFIED CONNECTION

(71) Applicant: HEWLETT PACKARD ENTERPRISE DEVELOPMENT LP, Houston, TX (US)

(72) Inventors: Bradley G Culter, Houston, TX (US); Charles E. Christian, Jr., Basking Ridge, NJ (US)

(21) Appl. No.: 15/507,101

(22) PCT Filed: Feb. 20, 2015
(86) PCT No.: PCT/US2015/016802

§ 371 Date: Feb. 27, 2017

(51) Int. Cl. H04L 12/24; H04L 12/26

(52) U.S. Cl. CPC H04L 41/0672; H04L 41/0668; H04L 43/0811

(57) ABSTRACT

Examples herein disclose detecting a modification to a first connection between components. In response to the detected modification, the examples provide a second connection redundant to the first connection. The second connection resumes a capability of the first connection.

### BACKGROUND

In engineering, redundancy is a duplication of critical components in a system to increase reliability of the system.

### BRIEF DESCRIPTION OF THE DRAWINGS

In the accompanying drawings, like numerals refer to like components or blocks. The following detailed description references the drawings, wherein:

FIG. 1 is a block diagram of an example device to detect a modification of a first connection and in response to provide a second connection as a redundant connection to the first connection;

FIG. 2 is a block diagram of an example storage device including a first processor and a second processor for detecting a modification to a first connection and creating a redundant second connection;

FIG. 3 is a diagram of an example system illustrating an implementation of infrastructure between a storage device, a switching component, and a network host;

FIG. 4 is a flowchart of an example method to detect a modification to a first connection and in response provide a second connection redundant to the first connection;

FIG. 5 is a flowchart of an example method to provide a second connection redundant to a first connection by disabling the first connection and enabling the second connection to resume a capability of the first connection;

FIG. 6 is a flowchart of an example method to control a switch for creating a connection through a port based on a detected modification; and

FIG. 7 is a block diagram of an example computing device with a first processor to execute instructions in a machine-readable storage medium for detecting a modification to a first connection which disables access to a second processor and creating a virtual second connection to enable access to the second processor.

### DETAILED DESCRIPTION

Providing path redundancy by providing redundant components may cause networking loops. These networking loops may create an endless loop which occurs in a network when multiple active paths are present. Various protocols exist that deal with these multiple active paths, such as a spanning tree protocol (STP). However, the STP increases resource costs as the protocols are complex and a system may need to undergo extensive testing prior to implementation in a customer's network.

To address these issues, examples efficiently handle a disconnection to a device. The examples provide a dynamic response in managing connections to maintain access to components internal to a disconnected device. The examples disclose a first processor to detect a modification to a connection which may disable access to the first processor. In response to the detected modification, a second processor provides a different connection which is considered redundant to the first connection. Providing the second connection enables access to the previously disconnected first processor. Providing the second connection as dynamic response avoids the complexity and resources of the STP. Additionally, the second connection provides access to the internally managed device through this redundant connection. Further, providing the redundant connection in response to the disconnection, avoids the networking loops that may cause confusion.

In another example, a single path connection is provided from the network to the device. In this example, if this single path becomes disconnected, the redundant connection provides access to manage the device from the network. Using the single path until detecting the disconnection, provides the redundant connection without redundancy costs associated with the redundant components.

In summary, examples disclosed an efficient mechanism to manage a disconnected device, while still enabling access to the device.

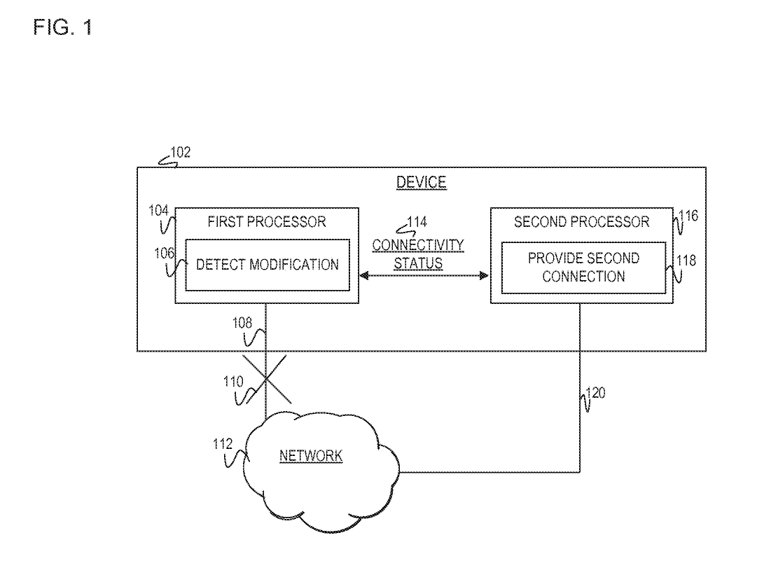

Referring now to the figures, FIG. 1 is a block diagram of an example device 102 including a first processor 104 and a second processor 116. The first processor 104 detects a modification 110 to a first connection 108 at module 106. Upon detecting the modification 110, the first processor 104 communicates with the second processor 116 to provide a second connection 120 at module 118. The second connection 120 is considered a redundant connection to the first connection 108 in the sense that the second connection 120 is used to gain access to the components within the device 102 from a network 112 that may have lost connection upon the modification 110. Although FIG. 1 illustrates the device 102 as including the first processor 104 and the second processor 116, this was done for illustration purposes as the device 102 may further include multiple memory controllers and/or multiple switches connected to the network 112. Additionally, there may be external switch(es) to the device 102 which may not be illustrated. This may be depicted in a later figure.

The device 102 is an enclosure including the first processor 104 and the second processor 116. In one implementation, the device 102 includes a storage area, such as a data center which may include multiple memory controllers (in addition to the processors 104 and 116) and multiple storage components. The device 102 represents a structure which includes a single path (e.g., the first connection 108) to the network 112 for accessing both processors 104 and 116. The network 112 may access these processors 104 and 116 to gain access to storage of the device 102. The first processor 104 may detect the disconnection of this single path. The disconnection of the single path leads to disabling access to the processors 104 and 116 and other such components internal to the device 102. As such, upon detecting the disconnection, the processors 104 and 116 communicate to create the second connection 120. The second connection 120 provides a mechanism in which to continue access to the components to the device 102.

The first processor 104 detects the modification 110 to the first connection 108 at module 106. In response, the first processor 104 communicates with the second processor 116 to provide the second connection 120. In an implementation, the first processor 104 is a high availability component internal to the device 102 that may be in continuous operation for a longer length of time. Implementations of the first processor 104 include a by way of example, a microprocessor, controller, processing unit, microcontroller, semiconductor, integrated circuit, or other type of electronic device.

At module 106, the first processor 104 detects the modification 110 to the first connection 108. The first processor 104 communicates the connectivity status 114 to the second processor 116, such as whether the first connection 108 has been disconnected, removed, and/or disabled. In other implementations, the first processor 104 detects the modification 110 by monitoring a switch coupled to the first processor 104. In this implementation, the first processor 104 monitors a register in the switch to detect the modification 110. Implementations of module 106 include by way of example, a set of instructions, process, operation, logic, technique, function, firmware, and/or software executable by the first processor 104 to detect the modification 110 to the first connection 108.

The first connection 108 is a physical wired or wireless connection between the network 112 and the device 102. In another implementation, the first connection 108 includes the connection between multiple switches. The modification 110 includes a change in connectivity to the first connection 108 and as such may include by way of example, a removal, disconnection, and/or addition of this connection. The type of modification 110 (e.g., removal, disconnection, addition) may determine the type of response provided. For example, if the modification 110 includes a disconnection (as indicated with the ‘X’), the type of response enacted by one of the processors 104 or 116 includes providing the second connection 120 as the redundant connection. This redundant connection provides access to those components which may be disconnected upon the disconnection of the first connection 108. In another example, if the modification 110 includes the addition of the first connection 108, it is assumed the second connection 120 may already be providing access to the device 102. As such, the response by one of the processors 104 or 116 includes disconnecting of the second connection 120 as the first connection 108 may resume access to the device 102. Although FIG. 1 illustrates the first connection 108 between the network 112 and the first processor 104 implementations should not be limited as this was done for illustration purposes. These examples are described in detail in later figures.

The network 112 is a data network which allows nodes to exchange data. These networked devices transfer data between each other in the form of packets. As such, the network 112 represents a type of networking system, such as the Internet, Ethernet, local area network (LAN), metropolitan area network (MAN), and/or wide area network (WAN).

The second processor 116, in response to the detected modification 110 to the first connection 108, provides the second connection 120 at module 118. In this implementation, the second processor 116 receives the connectivity status 114 from the first processor 104 indicating whether the first connection 108 has been removed, disconnected, etc. In a further implementation, the second processor 116 monitors the first connection 110 and provides the connectivity status 114 to the first processor 104. In this implementation, the first connection 108 is provided to the network 112 from the second processor 116. Upon the second processor 116 informing the first processor 104 of the modification 110, the first processor 104 proceeds to provide the second connection 120 to the network 112. In an implementation, the second processor 116 is a high availability component internal to the device 102 that may be in continuous operation for a longer length of time. Implementations of the second processor 116 include a by way of example, a microprocessor, controller, processing unit, microcontroller, semiconductor, integrated circuit, or other type of electronic device.

At module 118, the first processor 104 detects the modification 110 to the first connection 108. In one implementation, the first processor 104 receives and exchanges communications to the second processor 116 regarding a connectivity status 114 of the first connection 108. In this implementation, the connectivity status 114 enables both processors 104 and 116 to detect the modification 110 and respond though coordination of the second connection 120. In another implementation, the first processor 104 monitors a register internal to a switch (not illustrated), a change in a value of the register indicates to the first processor 104 the modification 110 of the first connection 108. Implementations of module 118 include by way of example, a set of instructions, process, operation, logic, technique, function, firmware, and/or software executable by the second processor 118 to provide the second connection 120 to the network 112.

The second connection 120 is provided as the redundant connection to the first connection 108. The redundancy in FIG. 1 indicates when the first connection 108 fails, the network 112 can access the device 102 through the second processor 116. In this manner, the second connection 120 provides access to the internally managed device 102 through this redundant connection.

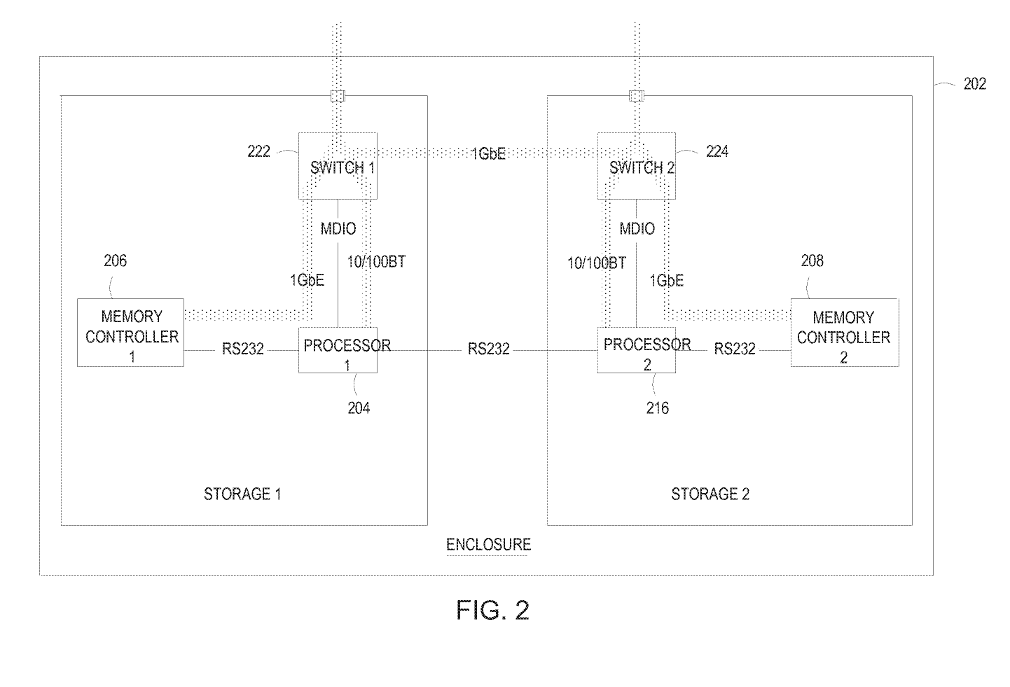

FIG. 2 is a block diagram of an example enclosure 102 including a first processor 204 and a second processor 216 for detecting a modification to a first connection and creating a redundant second connection. The first connection includes, by way of example, a physical connection between the first switch 222 and the second switch 224 or one of the switches 222 or 224 to a network. As such the modification to the first connection includes, by way of example, a disconnection between the switches 222 and 224 or between one of the switches 222 or 224 and the network. Detecting this disconnection, disables access to one of the processors 204 or 216 and in turn a corresponding memory controller 206 or 208. Thus the first processor 204 creates the second connection as redundant to the first connection to enable access to the disabled processor 204 or 216 and the corresponding memory controller 206 or 208. As such, providing the second connection as redundant to the first connection to continue access to the storage device 202, enables the first processor 204 to resume the capability of the first connection. Although FIG. 2 illustrates the switches 222 and 224 as internal to the storage device 202, this was done for illustration purposes as these switches 222 and 224 may be located externally to the storage device 202 as detailed in a later figure.

In implementations the first processor 204 may detect the modification to the first connection through monitoring a register internal to the first switch 222 or by receiving communications from the second processor 216 regarding the connectivity status.

The first processor 204, coupled to the first switch 222, detects the modification to the first connection by monitoring the register (not illustrated) internal to the first switch 222. The second processor 216, coupled to the second switch 224, monitors a register internal to the second switch 224. In this implementation, each register corresponding to the switch 222 and 224 tracks a particular port which includes the connection of the first connection. Each particular port may track the connection between the switches 222 and 224 or between the respective switch 222 or 224 and the network. If the value corresponding to one of these registers changes, this indicates to the respective processor 204 or 216 the modification (e.g., disconnection) of that connection. In this implementation, the first processor 204 is coupled to the first switch 222 for monitoring the register over a management data input/output (MDIO) as a serial management interface. In this implementation the second processor 216, coupled to the second switch 224, monitors an internal register to the second switch 224 using MDIO.

The first processor 204 may detect the modification to the first connection through communications from the second processor 216. In this implementation, the first processor 204 and the second processor 216 communicate the connectivity status of the first connection. In one implementation, the first processor 204 and the second processor 216 communicate between each other using a serial communication, such as RS-232. The RS-232 is a standard for serial communication of the transmission of data between the multiple processors 204 and 216. In this implementation, each processor 204 and 216 communicate to the corresponding memory controller 206 and 208 using this serial communication.

Upon detecting this modification, the first processor 204 creates the second connection as redundant to the first connection thus enabling access to previously disconnected component(s), such as one of the memory controllers 206 or 208, etc. Thus, the first processor 204 may create the second connection as redundant to the first connection so the network may continue to access the components in the storage device 202. In one implementation, the first processor 204 creates a virtual connection so traffic may continue to be delivered to the appropriate destination and/or so the network may continue to access the storage device 202.

For example, if there is a single path from the network into the first switch 222 and the first connection is lost between the first switch 222 and the second switch 224, then access from the network to the second processor 216 and the second memory controller 208 is lost. Thus, the second connection may be provided by the first processor 204 as the redundant to the connection between the switches 222 and 224 thus enabling access to the second processor 216 and in turn the second memory controller 208. In another example, assume there is a path from the network into each of the switches 222 and 224. In this example, if the path is lost between the network and the second switch 224, access to the second processor 216 and the second memory controller 208 may be lost. Thus, the first processor 204 may construct the second connection from the first switch 222 to the second switch 224 to enable access from the network to the second processor 216 and the second memory controller 208. This means if one of the paths into the storage device 202 fails, another connection is established to access the storage system.

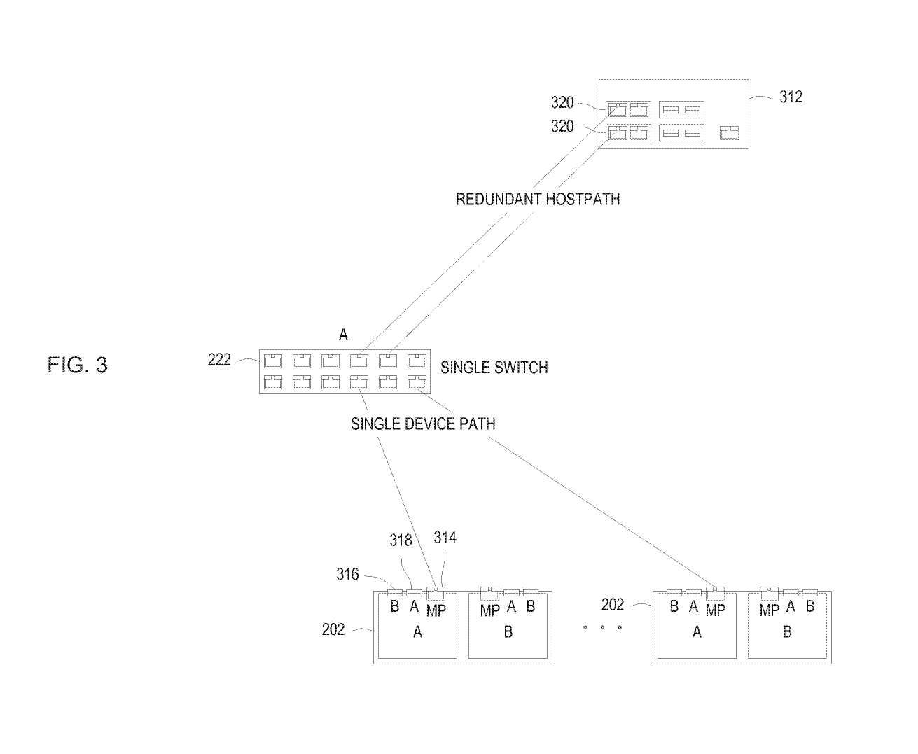

FIG. 3 is a diagram of an example infrastructure including multiple storage devices 202, a networking switch 222, and a host device 312. The infrastructure represents a network from the host device 312 to access to a data center holding the multiple storage devices 202. Specifically, FIG. 3 illustrates one implementation of a networking system including a first processor 318 and a second processor 316 within a storage device to detect a modified connection to the switch 222. In this implementation, the modified connection may disable access to from the storage device 202 to the switch 222. As such, disabling the access from the storage device 202 to the switch 222 means that the storage device 202 corresponding to the connection is disconnected from the host device 312 and in turn the network. In response, one of the processors 318 or 316 creates a second connection from the storage device 202 back to the switch 222. In this figure, the host device 312 includes a redundant host path connection through an Ethernet port 320. The host device 312 represents the connections from the switch 222 to the networking system. As such, the host device 320 may include a portal to a local area network (LAN), metropolitan area network (MAN), and/or wide area network (WAN). Although FIG. 3 illustrates a redundant host path between the host device 312 and the switch 222 and a single device path from the switch 222 to each of the multiple storage devices 202, this was done for illustration purposes and not for limiting implementations. For example, there may be single host path between the host device 312 and the switch 222. In another example, there may be a redundant device path from the switch 222 to each of the storage devices 202.

The location of the switch 222 is located externally to the storage device 202. As such to reconnect a modified connection from the switch 222 to the storage device 202, one of the processors 316 or 318 creates a virtual connection back to the switch 222. This enables access from the network to the storage device 202. Enabling access back to the storage device 202 from the network, reconfigures a management path from one of the storage devices 202 to the host device 312 and/or switch 222. In other implementations, the storage devices 202 may connect directly to the host device 312 rather than accessing the host device 312 through the switch 222.

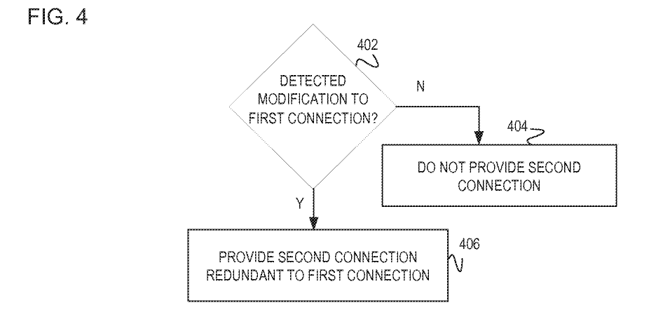

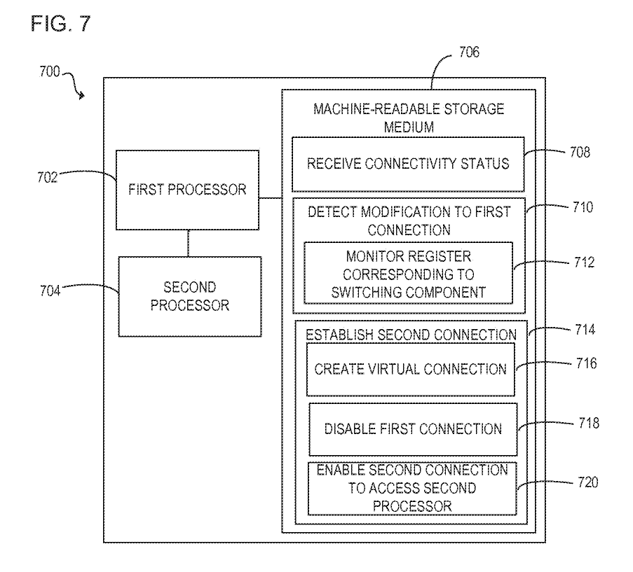

FIG. 4 is a flowchart of an example method, executable by a processor, to detect a modification to a first connection and in response provide a second connection redundant to the first connection. Upon the determination that the first connection has not been modified, the processor does not provide the second connection. The first connection includes a connection that may occur between multiple switching components (e.g., a first switching component and a second switching component) or between one of the switching components to the network. The modification includes a change to status of the first connection and as such may include by way of example, a removal, disconnection, and/or addition of this connection. When the disconnection of the first connection occurs, a network may be disabled from connecting to a different processor (e.g., second processor). Thus by creating the second connection, the second processor enables access to the disabled processor from the network. In discussing FIG. 4, references may be made to the components in FIGS. 1-3 to provide contextual examples. In one implementation, the first processor 104 and 204 as in FIGS. 1-2 executes operations 402-406 to detect the modification to the first connection and in response providing the second connection. Further, although FIG. 4 is described as implemented by the processor, it may be executed on other suitable components. For example, FIG. 4 may be implemented in the form of executable instructions on a machine-readable storage medium 706 as in FIG. 7.

At operation 402, the processor detects whether there is the modification to the first connection. In an implementation, the different processor (e.g., the second processor) communicates to the processor a connectivity status of the switching component connected to this other processor. This connectivity status allows the other processor to communicate with the processor in case there may be modifications which disables access from the network to this other processor. In another implementation, the processor monitors the register internal to a different switching component which is connected to the processor. In this implementation, the register internal to the connected switching component tracks a particular port which may include the connection (e.g., the first connection) to another switching component and/or the network. As such if the value on this register changes, this indicates to the processor the connection from that particular port has been removed. Thus, the processor may create the second connection as redundant to the first connection so the network may continue to access the processor. If the processor determines there is no modification, the processor proceeds to operation 404 and does not provide the second connection. If the processor determines there is the modification to the first connection, the processor proceeds to operation 406.

At operation 404, upon the determination there first connection has not been modified, the processor does not create the second connection. Determining there has been no modification to the first connection means the first connection may still be physically connected to another switching component and/or the network. The physical connection indicates the second processor may still be accessible.

At operation 406, upon the determination the modification occurred to the first connection, the processor proceeds to provide the second connection. The second connection resumes the capability of the first connection to ensure access. In this implementation, the second processor may become disabled and thus inaccessible from an external connection to the system, such as the network. The second connection is created as the redundant connection to the first connection, thus providing access to the second processor. In one implementation, the processor manages the connected switching component, thus enabling a virtual connection through the port.

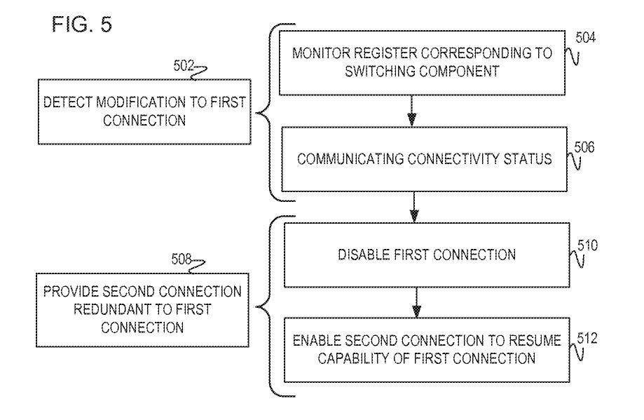

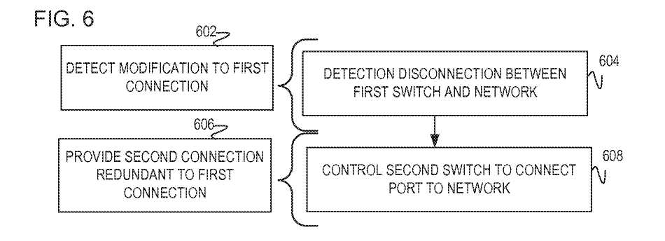

FIG. 5 is a flowchart of an example method, executable by a processor, to provide a second connection redundant to a first connection. FIG. 5 represents the flowchart of detecting a modification of a connection between multiple switching components or a disconnection of one of the switching components to a network. Detecting the disconnection of the switching component to the network is explained in detail in connection with FIG. 6.

The processor monitors a register internal a coupled switching component to identify a value of the register. The value indicates whether the first connection from that coupled switching component has been modified. In an alternative, the processor receives a connectivity status from a different processor. The different processor, coupled to the processor, transmits connectivity status and/or states of the first connection to the processor. Thus, the processor may detect whether the modification has occurred to this first connection. Upon detecting the modification to the first connection, the processor provides the second connection as a redundant connection to the first connection. In one implementation, the processor provides the second connection through disabling the first connection. Upon disabling the first connection (if not already done so), the processor proceeds to enable the second connection to resume a capability of the first connection. In discussing FIG. 5, references may be made to the components in FIGS. 1-3 to provide contextual examples. In one implementation, the first processor 104 and 204 as in FIGS. 1-2 executes operations 502-512 to detect the modification to the first connection and in response providing the second connection. Further, although FIG. 5 is described as implemented by the processor, it may be executed on other suitable components. For example, FIG. 5 may be implemented in the form of executable instructions on a machine-readable storage medium 706 as in FIG. 7.

At operation 502, the processor detects the modification to the first connection. The first connection exists as a connection between switching components or as a connection from one of the switching components to a network. As such, the removal and/or disconnection of this first connection means at least one of the components internal to a system is without access to an external component (i.e., outside of the system). This limits the capability of the system. Operation 502 may be similar in functionality to operation 402 as in FIG. 4.

At operation 504, the processor monitors the register corresponding to the switching component. The switching component is coupled to the processor, thus the processor may monitor the register internally located in the switching component. Monitoring the register tracks a port and the connectivity status of whether the port is currently connected to the second switch or to the network. In this implementation, if the register changes a value, this indicates to the processor the modification has occurred to the first connection.

At operation 506, the processor communicates the connectivity status of the first connection to a different processor. Alternatively, the processor may receive communications from the different processor (e.g., a second processor) indicating the status of the first connection. In this implementation, the processor detects the modification to the first connection through the communications from the different processor rather than from monitoring the register in the switching component.

At operation 508, the processor provides the second connection as the redundant connection to the first connection. In one implementation, the processor creates and builds a virtual connection in which an external entity to the system (e.g., the network) may gain access to the previously inaccessible second processor. Operation 508 may be similar in functionality to operation 406 as in FIG. 4.

At operation 510, upon the determination the modification has occurred to the first connection, the processor disables the first connection. In this implementation, the modification may include a partial disconnection thus the processor may proceed to fully disable the first connection.

At operation 512, upon disabling the first connection, the processor enables the second connection. In this implementation, the processor creates the virtual connection as redundant to the first connection to resume a capability. Resuming the capability of the first connection includes, by way of example, providing access to a component which may be have become inaccessible upon the modification to the first connection.

FIG. 6 is a flowchart of an example method, executable by a processor, to control a switch (e.g., first switch) for creating a connection through a port based on a detected modification. Specifically, the flowchart in FIG. 6 illustrates detecting a disconnection between the switch and the network. As such, the processor detects modification to the first connection by either monitoring a register internal to the first switch or detecting the modification to the first connection through communications by another processor. Monitoring the register tracks a port and the connectivity status of whether the port is currently connected to the second switch or to the network. Monitoring the register, the processor can detect the disconnection from the first switch and the network. In the implementation of exchanging communications the processor is coupled to the first switch while another processor is coupled to the second switch. Both processors communication the connectivity status of the first connection of their respective switches to the network. Alternatively, FIG. 6 may also detect the disconnection between the first switch and a second switch as described in connection with FIGS. 1-3. Upon detecting the disconnection between the first switch and the network, the processor provides a second connection as redundant to the first connection. Providing the second connection, the processor enables access to component(s) which may have been inaccessible upon the disconnection. The processor may provide the second connection through controlling the second switch to connect to the network. In this implementation, the processor communicates to the other processor which is coupled to the second switch to create a virtual connection through the second switch to the network. In discussing FIG. 6, references may be made to the components in FIGS. 1-3 to provide contextual examples. In one implementation, the first processor 104 and 204 as in FIGS. 1-2 executes operations 602-608 to detect the modification to the first connection and in response providing the second connection. Further, although FIG. 6 is described as implemented by the processor, it may be executed on other suitable components. For example, FIG. 6 may be implemented in the form of executable instructions on a machine-readable storage medium 706 as in FIG. 7.

At operation 602, the processor detects the modification to the first connection. In one implementation, the processor proceeds to operations 604 for detecting the modification. In this implementation, the first connection is considered a connection located between the first switch and the network. Thus, the processor monitors a register internal to the first switch to track whether the register value has changed, thus indicating a modification to the first connection. Operation 602 may be similar in functionality to operations 402 and 502 as in FIGS. 4-5.

At operation 604, the processor detects whether a disconnection has occurred between the first switch and the network. As such, the processor monitors the register internal to the first switch to determine whether the value corresponding to the register has changed. If the value has changed, this indicates to the processor the disconnection between to the network. Disconnecting from the network, prevents the network from accessing components, such as the processor or a different processor (e.g., the second processor) to further gain access to memory or storage. Thus, the processor creates the second connection in order to regain access to the previously disconnected components.

At operation 606, in response to the modification detected at operation 602, the processor provides the second connection as a redundant connection to the first connection. In one implementation, the processor provides the second connection as a virtual connection by controlling a second switch coupled to the processor as at operation 610. Operation 608 may be similar in functionality to operations 406 and 508 as in FIGS. 4-5.

At operation 608, the processor controls the second switch to connect the port to the network. Creating the connection from the second switch to the network, provides the redundant connection which was disconnected at operation 606. Providing the redundant connection, the processor enables access to those disconnected components.

FIG. 7 is a block diagram of computing device 700 with a first processor 702 to execute instructions 708-720 within a machine-readable storage medium 704. Specifically, the computing device 700 with the first processor 702 is to detect a modification to a first connection. The modification to that first connection disables access to a second processor, thus creating a second virtual connection enables access to the disabled second processor. Although the computing device 700 includes the first processor 702, second processor 704, and machine-readable storage medium 706, it may also include other components that would be suitable to one skilled in the art. For example, the computing device 700 may include at least one of the memory controllers and/or storage components as in FIG. 2. The computing device 700 is an electronic device with the first processor 702 capable of executing instructions 708-720, and as such embodiments of the computing device 700 include a server, data center, mobile device, client device, personal computer, desktop computer, laptop, tablet, or other type of electronic device capable of executing instructions 708-720. The instructions 708-720 may be implemented as methods, functions, operations, and other processes implemented as machine-readable instructions stored on the storage medium 706, which may be non-transitory, such as hardware storage devices (e.g., random access memory (RAM), read only memory (ROM), erasable programmable ROM, electrically erasable ROM, hard drives, and flash memory).

The first processor 702 may fetch, decode, and execute instructions 708-720 to provide access to the disabled second processor 704 by creating the second virtual connection. In one implementation, upon executing instruction 708, the first processor 702 may execute instruction 710 through the execution of instruction 712. In another implementation upon executing instructions 708-712, the first processor 702 may execute instruction 714 through a combination of executing instructions 716-720. Specifically, the first processor 702 executes instructions 708-712 to: receive a connectivity status of the first connection from the second processor; based on this connectivity status, the first processor 702 detects the modification to the first connection; and/or monitors a register internal to a switching component to detect the modification to the first connection. The first processor 702 may proceed to execute instructions 714-720 to: establish the second connection in response to the detected modification of the first connection; create the virtual connection for establishing the second connection; disable the first connection; and enable the second connection so access is provided to the second processor.

The machine-readable storage medium 706 includes instructions 706-720 for the first processor 702 to fetch, decode, and execute. In another embodiment, the machine-readable storage medium 706 may be an electronic, magnetic, optical, memory, storage, flash-drive, or other physical device that contains or stores executable instructions. Thus, the machine-readable storage medium 706 may include, for example, Random Access Memory (RAM), an Electrically Erasable Programmable Read-Only Memory (EEPROM), a storage drive, a memory cache, network storage, a Compact Disc Read Only Memory (CDROM) and the like. As such, the machine-readable storage medium 706 may include an application and/or firmware which can be utilized independently and/or in conjunction with the first processor 702 to fetch, decode, and/or execute instructions of the machine-readable storage medium 706. The application and/or firmware may be stored on the machine-readable storage medium 706 and/or stored on another location of the computing device 700.

We claim:

1. A method, executable by a processor, the method comprising:
detecting a modification to a first connection between components;
in response to the detected modification, providing a second connection, redundant to the first connection, wherein the second connection resumes a capability of the first connection.

2. The method of claim 1 wherein detecting the modification to the first connection between components comprises:
communicating a connectivity status to detect the modification to the first connection, the communication between the processor and a different processor.

3. The method of claim 1 wherein providing the second connection comprises:
disabling the first connection based on the detected modification; and
enabling the second connection to resume the capability of the first connection.

4. The method of claim 1 wherein detecting the modification to the first connection between components comprises:
monitoring a register corresponding to a switching component; and
detecting a disconnection between the switching component and a network. e

5. The method of claim 1:
wherein detecting the modification comprises detecting a disconnection on a first switch to a network which disconnects access from the network to a different processor; and
wherein providing the second connection comprises controlling a second switch to connect a port corresponding to the second switch to the network, the connected port provides access to the disconnected processor.

6. The method of claim 1 wherein detecting the modification to the first connection comprises:
monitoring the first connection between a first switch and a second switch internal to a device.

7. A device comprising:
a first processor, coupled to a second processor, to:
detect a modification to a first connection, the modification disables access to the first processor from a network; and
communicate a connectivity status of the first connection to the second processor;
the second processor to:
in response to the detected modification, provide a second connection redundant to the first connection so the second connection enables access to the first processor from the network.

8. The device of claim 7 comprising:
a first switching component, coupled to the first processor, to provide the first connection to the network; and
a second switching component, coupled to the second processor, to provide the second connection to the network for accessing the first processor.

9. The device of claim 7 comprising:
a first memory controller, coupled to the first processor, to access a first memory, wherein upon the disablement of access to the first processor disables access to the first memory;
a second memory controller, coupled to the second processor, to access a second a second memory.

10. The device of claim 7 wherein the second processor is to:
disable the first connection; and
create a virtual connection redundant to the first connection.

11. The device of claim 7 wherein the first processor is to monitor a register internal to a switching component for detection of a modification to the first connection.

12. A non-transitory machine-readable storage medium comprising instructions that when executed by a first processor causes the first processor to:
receive connectivity status of a first connection from a second processor;
detect a modification to the first connection; and
in response to the detected modification, establish a second connection redundant to the first connection, wherein the second connection resumes a capability of the first connection.

13. The non-transitory machine-readable storage medium including the instructions of claim 12 wherein the detected modification disconnects access to the second processor from a network and further wherein to establish the second connection redundant to the first connection comprises instructions that when executed by the first processor cause the first processor to:
provide access to the disconnected second processor through a creation of a virtual connection from a switching component to the network.

14. The non-transitory machine-readable storage medium including the instructions of claim 12 wherein to detect the modification of the first connection comprises instructions that when executed by the first processor cause the first processor to:
monitoring a register corresponding to a switching component, a value of the register corresponds to the detected modification.

15. The non-transitory machine-readable storage medium including the instructions of claim 12 comprising instructions that when executed by the first processor cause the first processor to:
disable the first connection based on the detected modification; and
enable the second connection to access the second processor.
